(19) United States
(12) Patent Application Publication
(10) Pub. No.: US 2026/0148260 A1
(43) Pub. Date: May 28, 2026

(54) POWERBANK WITH INTEGRATED MEDIA DISPLAY

(71) Applicant: Trevor Shaw, Lehi, UT (US)

(72) Inventor: Trevor Shaw, Lehi, UT (US)

(21) Appl. No.: 18/959,579

(22) Filed: Nov. 25, 2024

(51) Int. Cl. G06Q 30/0251; G06F 3/0488; G06F 3/14; G06Q 30/0645; H02J 50/10

(52) U.S. Cl. CPC G06Q 30/0267; G06F 3/14; G06Q 30/0255; G06Q 30/0261; G06Q 30/0269; H02J 50/10; G06F 3/0488; G06Q 30/0645

(57) ABSTRACT

A method of loading one or more predetermined advertisements onto a powerbank having a display and displaying said advertisement(s) on the display of said powerbank to a user leasing the powerbank from a terminal operable to dispense powerbanks, the terminal under the control of a technology provider.

### BACKGROUND OF THE INVENTION

### Field of the Invention

This invention relates generally to powerbanks, and more specifically relates to powerbanks with integrated media playback operability.

### Description of the Related Art

Terminals for charging batteries of portable devices (i.e., mobile phones, laptops, PDAs) are known in the art. It is an object of the present invention to achieve novelty by expanding the functionality of these terminal due to include means for sending advertising information to powerbanks dispensed from terminals.

Leasable powerbanks are known in the art and often dispensed from terminals where a consumer makes purchase for lease using a credit card or debit card from a merchant data processing device. At present, such powerbanks typically include power supplies in form of batteries such as a lithium-ion battery. These devices may also include mobile internet hotspots.

The prices charged for leasing a powerbank fluctuate with changing demand, the costs of hardware, and availability of substitute hardware at locations such as airports. Consumers who use powerbanks are typically tech-savvy and more likely than a typical consumer to purchase tech-related products and services, but also to take portable chargers and powerbanks with them to avoid cost-prohibitive pricing.

The disadvantages of the known devices include an inability of these devices to interact or direct information to a user of the powerbank and failure to take advantage of the opportunity for free movement of information between the user and one or more third parties. Known devices typically comprise housings with ports and charging cords, but not GUIs or other types of displays. The restricted condition of what can easily be an interactive device constitutes an inefficiency in the art.

The technical problem solved by the present invention ensure constant full communication of products and services to renters of powerbanks. Through the present invention, advertisements may be routed of reliable precision in real time in certain public areas. During the time that users are charging a mobile phone, the user may be particularly receptive in the absence of the DPD to advertisements displayed upon the display of the powerbank.

It would be advantageous in the art to provide a powerbank leasing terminal in public places which was paid for by third-party advertisers.

### SUMMARY OF THE INVENTION

From the foregoing discussion, it should be apparent that a need exists for a powerbank with an integrated media playback display. Beneficially, such a system, apparatus and method would provide a powerbank with media playback operability.

The present invention has been developed in response to the problems and needs in the art that have not yet been fully solved by currently available apparati and methods. Accordingly, the present invention has been developed to provide a computer-implemented method for loading advertisements onto a powerbank in response to input of personally-identifying information, the steps of the method comprising: accepting a plurality of advertisements over a WAN into computer-readable memory of a terminal operable to lease a plurality of powerbanks; collecting personally-identifying information from a prospective user into memory of the terminal; collecting GPS data from the prospective user; determining a predetermined advertisement from the plurality of advertisements to load into the memory of a powerbank through cross-referencing the personally-identifying information and the historical information; loading the predetermined advertisement into the memory of the powerbank; leasing the powerbank to a user from a kiosk; displaying the predetermined advertisement to the user; and requiring a user to respond with tactile input to the predetermined advertisement before dispensing power to the user's DPD from the powerbank.

The predetermined advertisement may be loaded onto the powerbank using a LAN. The powerbanks may be charged only through inductive charging in some embodiments.

The powerbanks may be ejected from the kiosk upon storing personally-identifying information in the kiosk.

The personally-identifying information may be collected from the user's phone using a mobile phone application given permission to collect the personally-identifying information from the user's phone.

Additional monies are charged, in some embodiments, to the user when the charge in the powerbank is depleted.

A second computer-implemented method for loading advertisements onto a powerbank is provided in response to input of personally-identifying information, the steps of the method comprising: accepting a plurality of advertisements over a WAN into computer-readable memory of a terminal operable to lease a plurality of powerbanks; collecting personally-identifying information from a prospective user into memory of the terminal; collecting GPS data from the prospective user; determining a predetermined advertisement from the plurality of advertisements to load into the memory of a powerbank through cross-referencing the personally-identifying information and the historical information; loading the predetermined advertisement into the memory of the powerbank; leasing the powerbank to a user from a kiosk; wherein the personally-identifying information is collected from the user's phone using a mobile phone application given permission to collect the personally-identifying information from the user's phone; displaying the predetermined advertisement to the user; and requiring a user to respond with tactile input to the predetermined advertisement before dispensing power to the user's DPD from the powerbank.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is forward perspective view of a powerbank dispensing terminal with powerbanks having integrated media displays in accordance with an embodiment of the present invention;

FIG. 1B is forward, environmental perspective view of a powerbank having an integrated media display in accordance with an embodiment of the present invention;

FIG. 2 is forward perspective view of a powerbank with an integrated media display in accordance with an embodiment of the present invention;

FIG. 3A is forward perspective view of a powerbank dispensing terminal in accordance with an embodiment of the present invention;

FIG. 3B is forward perspective view of a powerbank dispensing terminal in accordance with an embodiment of the present invention;

FIG. 3C is an environmental, forward perspective view of a powerbank dispensing terminal in accordance with an embodiment of the present invention;

FIG. 4 is an entity-relationship diagram illustrating data flow between entities in accordance with the present invention;

FIG. 5 is a flow chart of a method used by the system of FIG. 1 to broker real-world transactions; and

FIG. 6 is a block diagram illustrating modules of a system in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The embodiments of the present invention described herein generally provide for a system, apparatus, computer program product, and a method for mitigating instances of card holder fraud using image capture. Those individuals and entities purchasing a consumer good, service or any other product at a point of sale terminal (POS) are referred to herein as consumers, shoppers or requestors and these terms are used synonymously throughout this specification. Similarly individuals or organizations who are willing to provide the desired goods and services are herein referred to as merchants, while organizations authorizing purchases are referred hereinafter as merchant processors or clearinghouse system. Additionally, the community described herein may be referred to as a network as used throughout this specification. Consumers and merchants may also be referred to collectively hereinafter as users.

Hence, in general terms, the present invention provides for a powerbank with an integrated promotional display.

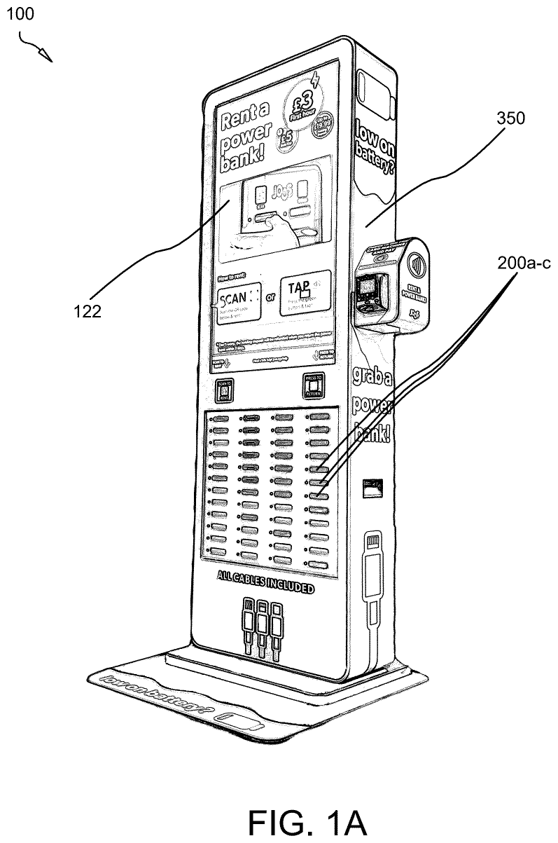

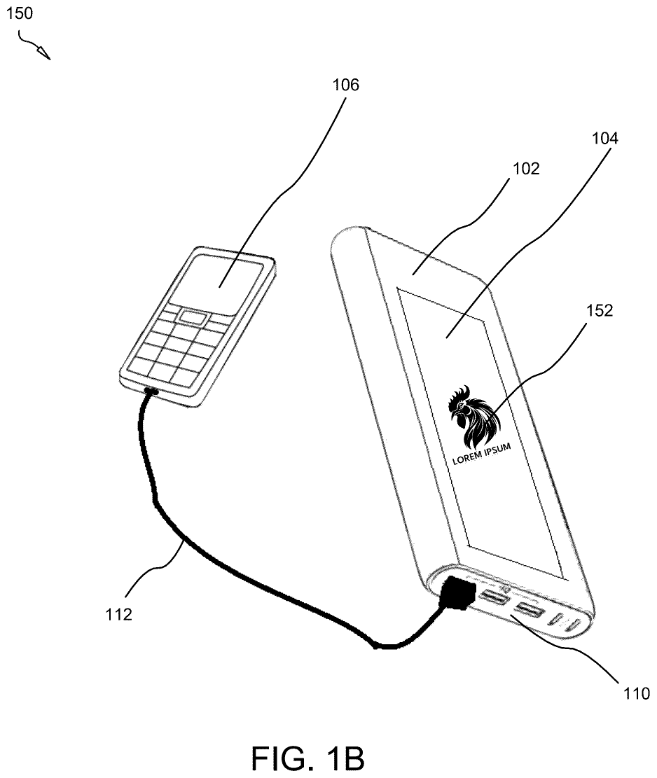

Accordingly, FIG. 1A is forward perspective view of a powerbank dispensing terminal (i.e., kiosk) with powerbanks having integrated media displays in accordance with an embodiment of the present invention.

The terminal 100 shown contains powerbanks 200 with expanded functionality and touch displays capable of receiving tactile input from a user 382.

The proposed system has expanded functionality which transmits in real time, or loads before use, advertisements 152 onto a powerbank 200. The user in the can freely move about a public space, such as an airport, while viewing the advertisements 152 on the display 104 of the powerbank 200. Upon completion of charging, the user can be obligated to return the powerbank 200 to the terminal 100.

The user 382 of data-processing device (DPD) such as a mobile phone has need to charge the DPD. While waiting in a public area, such as an airport, the user 382 approaches the terminal 100 and examines the terms of service on the display 122 of the terminal 100 in some embodiments. The user 382 may selects a payment method at the terminal and other conditions provided by a technology provider managing the terminal 100. The user 382 may be prompted to register with the terminal 100 or technology provider. During this process, certain demographic information about the user 382 may be collected by the system 600, including residence, credit ratings, name and other information which may be used in selecting advertisement 152 to display on a powerbank 200 to the user 382.

This information having been collected, and the terminal 100 paid, the user 382 is dispensed a powerbank 200 from the terminal 100.

At the request of an interested advertiser in logical communication with the technology provider, it is possible to preload the powerbank 200, or relay via a LAN or WAN, advertisements to the user 382. Because the user 382 is charging its DPD during this time, the user 382 may not have regular access to the DPD and may be particularly receptive in the absence of the DPD to advertisements 152 displayed upon the display 104.

The terminal 100 is preferably equipped with a plurality of powerbanks 200 stored in a fully charged status, which in turn are equipped with wifi connectivity and displays 104.

Thus, upon completion of use, the powerbank 200 is inserted (returned) by the user 382 in a port in the terminal 100.

FIG. 1B is a forward perspective view of a powerbank with an integrated media display 150 in accordance with an embodiment of the present invention.

The powerbank 102 comprises a GUI display 104 disposed upon a face 110 of the powerbank 102. In various embodiments, the powerbank 102 comprises cables 112 necessary to power one or more data processing devices (DPDs) such as mobile phone 106, and the powerbank 102 may also comprise hardware 108 necessary to power the powerbank 102 from an external power supply.

In various embodiments, the powerbank 200 is configured using means known to those of skill in the art only to output power such that the powerbank 200 itself cannot be charged. As such, the powerbank 200 contains no charging port or cables for receiving power directly. In these embodiments, the powerbank 200 is charged slowly via magnetic induction within the kiosk 100.

The kiosk 300 may use electromagnetic induction to provide electricity to portable devices. Inductive charging is also used in vehicles, power tools, electric toothbrushes, and medical devices. The powerbanks 200 can be placed into the racks 302 and charge in place without needing to be precisely aligned or make electrical contact with a dock or plug.

Inductive charging is named so because it transfers energy through inductive coupling. First, alternating current passes through an induction coil in the charging station or pad. The moving electric charge creates a magnetic field, which fluctuates in strength because the electric current's amplitude is fluctuating. This changing magnetic field creates an alternating electric current in the portable device's induction coil, which in turn passes through a rectifier to convert it to direct current. Finally, the direct current charges a battery or provides operating power.

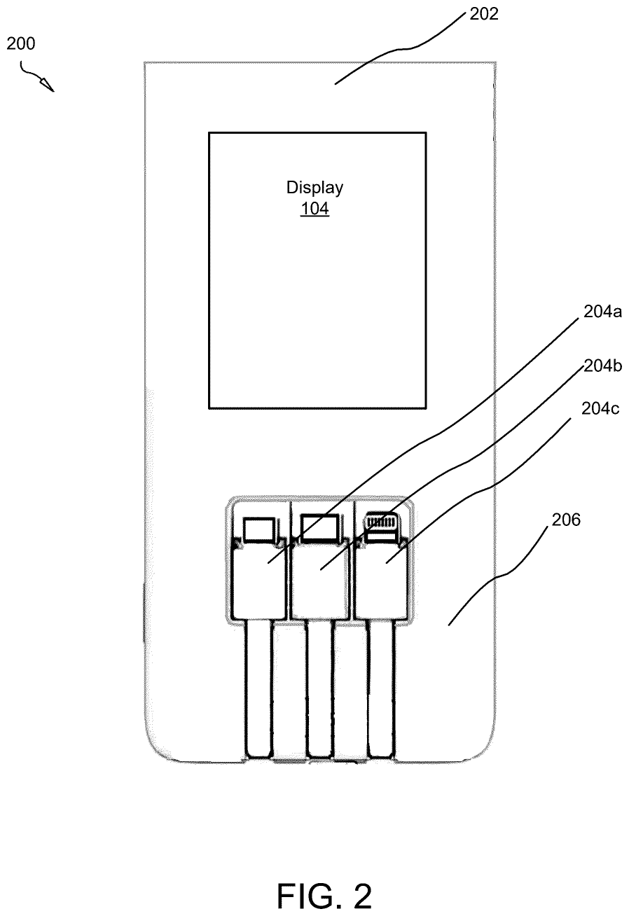

FIG. 2 is a forward perspective view of a powerbank with an integrated media display 200 in accordance with an embodiment of the present invention.

The powerbank 200 comprises a housing 206 and an internal power supply. The powerbank 200 may comprise a plurality of connectors for powering and providing data to DPDs, such as a USB-C connector 204b, a USB-B connector 204a, and USB-A connector.

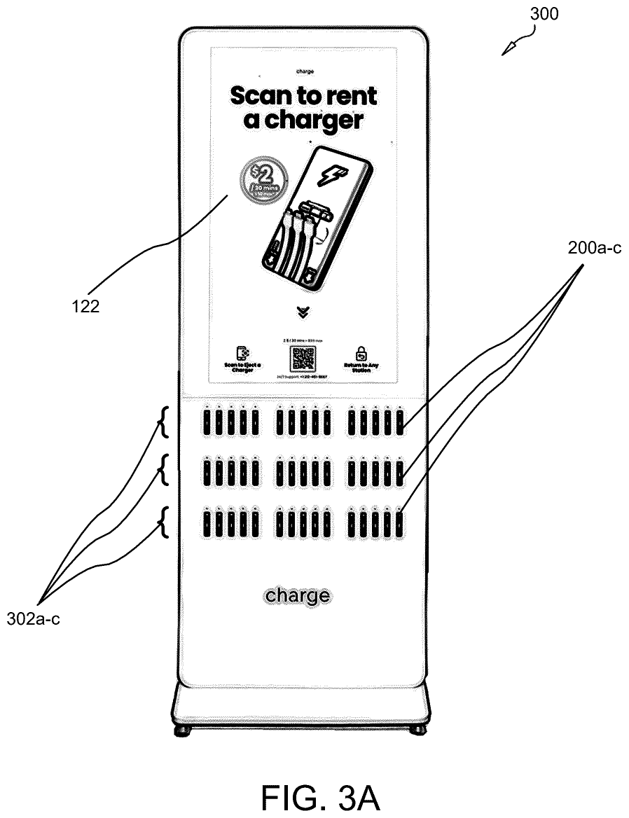

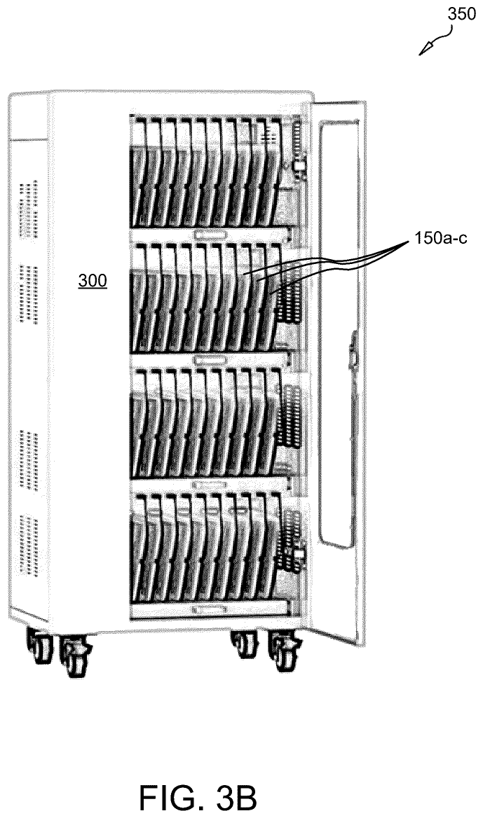

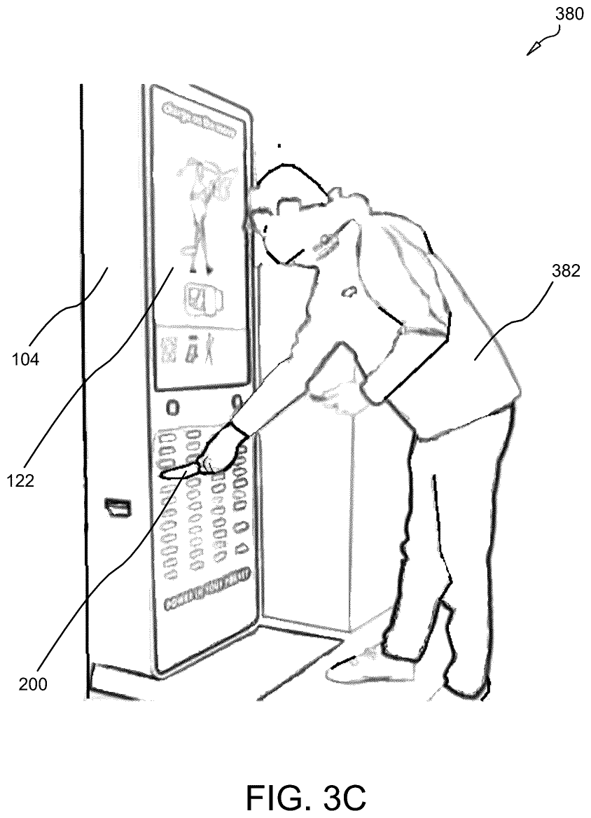

FIG. 3A is forward perspective view of a powerbank dispensing terminal 300 in accordance with an embodiment of the present invention.

The terminal 300 is equipped with a display 122 for interfacing with the user 382 before rental of a powerbank 200 is effectuated.

The kiosk 300 shown may comprise or consist of a mobile charging station with multiple power bank racks 302, and a display 122.

A power bank 300 with dispensing capacity of 15, 30 or 45 powerbanks 200 is shown. In some embodiments, a user 382 is first prompted to download a mobile application 622 on the user's 382 phone which mobile phone application imparts functionality to the user 382 to remotely rent and eject a powerbank 200 from the kiosk 300 via a mobile phone or DPD. After downloading the mobile phone application 622, the user 382 is prompted to add a name, address, mobile phone number and other personally identifying information 606, including payment information. The payment may be made using cryptocurrency, such as Bitcoin. Then user 382 is prompted to selecta buy or rent option.

The user 382 may be charged by the minute or hour for use, or for an unlimited time but only until a battery charge in the powerbank 200 is entirely depleted or depleted to the point that LAN communication with the powerbank 200 fails. User can use such power bank device for the selected time period, before finishing the due time, user need to return power bank anywhere nearby charging station. Amount has automatically debited from the wallet as per the user selected option. Further, the present invented kiosk system may automatically charge user while the power bank is not returned, the amount has debited from the security deposit wallet.

The present invented kiosk system further has a dispensing structure that allows the verify power bank to be vended to the user. A return structure of the kiosk has an openable door and a sensor that allows a user to return a rented power bank, and allows the kiosk to identify/verify the returned power bank. The returned batteries are stored in a return power bank rack which is connected to the return structure. An operator may access the returned power bank rack and move them to the charging unit, which may be in the kiosk, or external. Further, a sensor may identify/verify that a power bank has been returned through the return structure and update on server. For example, the sensor may sense that a power bank are received in the return structure.

FIG. 3B is a forward perspective view of a powerbank dispensing terminal 350 in accordance with an embodiment of the present invention.

In various embodiments, the terminal 300 dispenses powerbanks 102 to consumers/users 382 leasing or registering to take possession of said powerbanks 102. The leasing of powerbanks 150 may be realized using means known to those of skill it the art.

FIG. 3C is an environmental, forward perspective view of a powerbank dispensing terminal 380 in accordance with an embodiment of the present invention.

In various embodiments, a user 382 receives a powerbank 200 which is released or ejected from the terminal 380 after completion of a payment and/or registration process via the display 122.

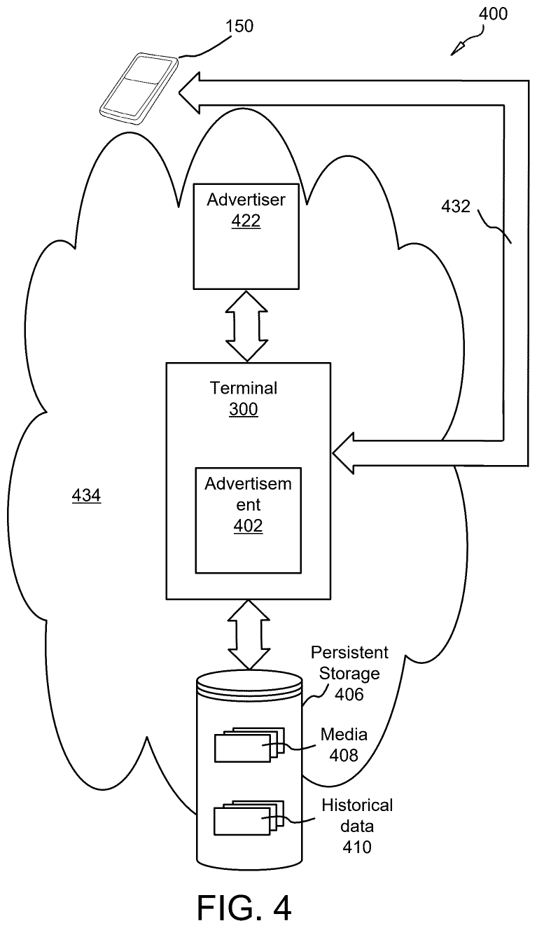

FIG. 4 is an entity-relationship diagram illustrating data flow between entities in accordance with a system 400 of the present invention.

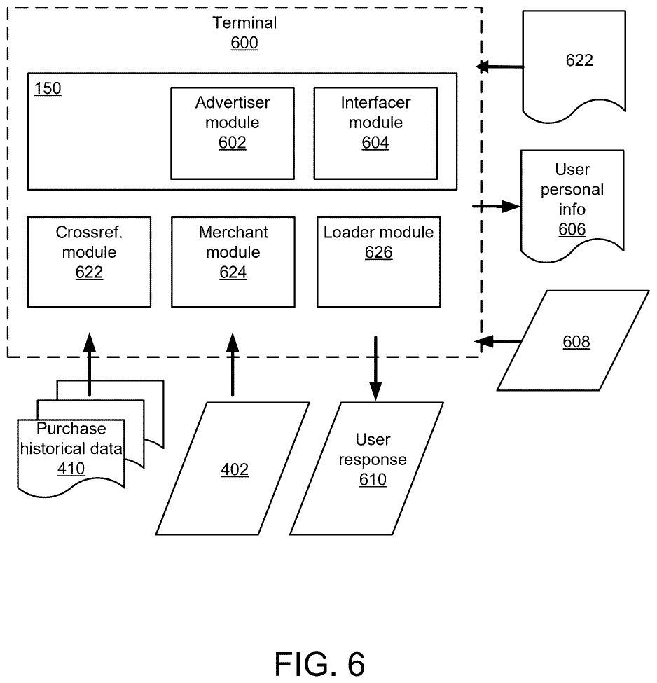

Accordingly, as illustrated in FIG. 4, dataflow involving a powerbank brokering system, or dispensing unit 300, is shown in accordance with an embodiment of the present invention for brokering powerbanks 100. The system 400 is shown and described further broadly in FIG. 6. The system 400 can receive real time data from customers leasing the powerbank 100, and can analyze the real time data along with previously stored data to match preferences of the customer with advertisement 402 available for transmittal via a datastream 432 to the leased powerbank 100. Monetary transactions between customers the system 400 are realized using means known to those of skill in the art, but the datastream 432 is unique in that it comprises media sent with to the powerbank 100, in some embodiments, customized for a user through reference to historical data 410. The system 400 can also adjust the advertising matches based on previously stored preference data from other third parties interfacing with a technology provider. In this way, the system 400 can dynamically modify advertisements displayed on a powerbank 100 to correlate with user preferences.

The advertisements 402 may comprise one or more of images, hyperlinks, video, audio and the like, all of which are displayed through the GUI 104.

The system 400 can include an interface capable of receiving tactile input from a user, such as a touchscreen indicated generally at 104, for interacting with a user and directing the user to an advertiser 422 providing the advertisement 402.

In one aspect, the powerbank not only supplies power to a mobile device but communicates via a network 434 with a technology provider controlling the terminal 300. The network may comprise a WAN or LAN.

The system 400 can also include a processor, persistent storage 406, and stored media 408.

In this way, the system 400 and/or terminal 300 may include one or more processors that execute instructions on a computer-readable medium, such as a central processing unit, indicated generally at, or digital memory storage device, that cause the one or more processors to make a determination of what media to display on a powerbank 100.

In other embodiments, the user is required to register with the terminal 300 or provider personally identifying information via a credit card, which information can be used to make a determination of which advertisement 402 in memory 406 to display on powerbank 100. In various embodiments, the advertisement 402 is loaded into media on the powerbank 100 before the powerbank 100 is dispensed to a user via a datastream while the powerbank 100 in internal to the terminal 300.

In one aspect, the system 400 can also include a plurality of powerbanks 100a-c, each capable of generating GPS location data. In this case, a user's GPS location data can be correlated with the terminal's 300 GPS location data such that the processor can determine a advertisers 422 in close proximity to a user and display advertisements 402 exclusively associated with said advertiser 422.

In another aspect, the one or more processors can include programming to make a determination of the advertisements 402 to be displayed.

In yet another aspect, the one or more processors can include programming to make a determination of available advertisers 422 based on GPS data from the user.

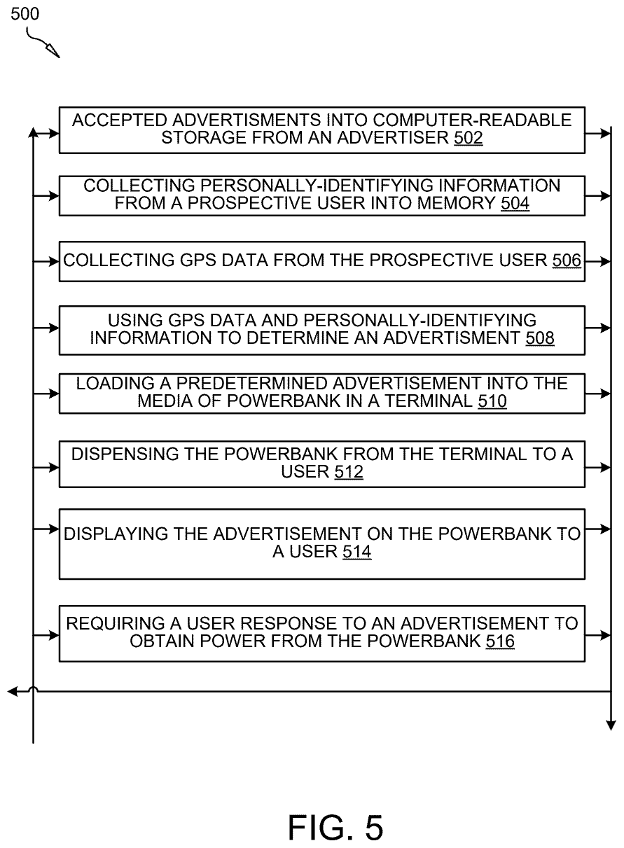

FIG. 5 is a flow chart of a method 500 used to display advertisements on a powerbank in accordance with the present invention.

In the method 500, advertisements 402 are accepted 502 in computer-readable memory 406. Personally-identifying information is collected 504 from the prospective user, including a name on a credit card, a credit card number, a name input into the terminal 300, and the like. GPS data is also collected 506 from a user and/or the terminal 300 for use 508 in determining 508 which advertisement 402 in memory 406 to load 510 on a powerbank 100 stored within the terminal 300 and dispensed 512 to a user.

The powerbank 100 may comprise the internal logic and programming necessary to withhold power dispensed from the powerbank 100 to a user's DPD until a user tactiley interfaces with a GUI 104 and/or an advertisement 402.

FIG. 6 is a block diagram illustrating modules of a system 600 in accordance with the present invention.

The system 600 comprises a powerbank 150 having an advertiser module configured to display advertisements 402, 152 loaded by a terminal 300 onto the powerbank 150. These advertisements 152 are then display on the GUI 104 on the powerbank 150. Once an advertisement 152 has been displayed by the advertiser module 602 within the powerbank 150, the interface module 604 determines what response 610 a user 382 inputs tactiley into the powerbank 150 in response to the advertisement 402, 152.

In those embodiments in which the powerbank 150 is in realtime communication with the terminal 600, 300 via a LAN or WAN, the cross-referencer module 622 is configured to cross-reference personally-identifying information 606 collected from a user 382 with historical data 410 to determine which of a plurality of advertisements 402 in memory 406 are most probable to garner a desired response 610 from a user 382 and/or prospective user.

The loader module 626 is configured to load an advertisement 402, 152 from an advertiser 422 into the memory of a powerbank 150 for display from the advertiser module 602.

The merchant module 624 is configured to process a lease payment for a user 382 using means known to those of skill in the art, or a payment for a product or service features in an advertisement 152.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer-implemented method for loading advertisements onto a powerbank in response to input of personally-identifying information, the steps of the method comprising:
accepting a plurality of advertisements over a WAN into computer-readable memory of a terminal operable to lease a plurality of powerbanks;
collecting personally-identifying information from a prospective user into memory of the terminal;
collecting GPS data from the prospective user;
determining a predetermined advertisement from the plurality of advertisements to load into the memory of a powerbank through cross-referencing the personally-identifying information and the historical information;
loading the predetermined advertisement into the memory of the powerbank;
leasing the powerbank to a user from a kiosk;
displaying the predetermined advertisement to the user; and
requiring a user to respond with tactile input to the predetermined advertisement before dispensing power to the user's DPD from the powerbank.

2. The method of claim 1, wherein the predetermined advertisement is loaded onto the powerbank using a LAN.

3. The method of claim 1, wherein the powerbanks can be charged only through inductive charging.

4. The method of claim 1, wherein the powerbanks are ejected from the kiosk upon storing personally-identifying information in the kiosk.

5. The method of claim 1, wherein the personally-identifying information is collected from the user's phone using a mobile phone application given permission to collect the personally-identifying information from the user's phone.

6. The method of claim 1, wherein additional monies are charged to the user when the charge in the powerbank is depleted.

7. A computer-implemented method for loading advertisements onto a powerbank in response to input of personally-identifying information, the steps of the method comprising:
accepting a plurality of advertisements over a WAN into computer-readable memory of a terminal operable to lease a plurality of powerbanks;
collecting personally-identifying information from a prospective user into memory of the terminal;
collecting GPS data from the prospective user;
determining a predetermined advertisement from the plurality of advertisements to load into the memory of a powerbank through cross-referencing the personally-identifying information and the historical information;
loading the predetermined advertisement into the memory of the powerbank;
leasing the powerbank to a user from a kiosk;
wherein the personally-identifying information is collected from the user's phone using a mobile phone application given permission to collect the personally-identifying information from the user's phone;
displaying the predetermined advertisement to the user; and
requiring a user to respond with tactile input to the predetermined advertisement before dispensing power to the user's DPD from the powerbank.
